(19) United States
(12) Patent Application Publication
(10) Pub. No.: US 2006/0152579 A1
(43) Pub. Date: Jul. 13, 2006

(54) Stereoscopic imaging system

(75) Inventors: Kei Utsugi, Kawasaki (JP); Takafumi Koiki, Sagamihara (JP); Michio Oikawa, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Displays, Ltd., Chiba (JP)

(21) Appl. No.: 11/316,240

(22) Filed: Dec. 21, 2005

(30) Foreign Application Priority Data
Dec. 24, 2004 (JP) 2004-374113

(51) Int. Cl. H04N 13/04; H04N 13/00; H04N 15/00

(52) U.S. Cl. 348/51; 348/42

(57) ABSTRACT

The present invention provides a stereoscopic image display system, which makes it possible to alleviate the burden on a viewer from fatigue when it is attempted to display an object at a position separated from a display screen. The stereoscopic image display system 500 comprises a stereoscopic image output unit 100, a stereoscopic imaging system 501, and an input unit 502, and a conversion program 614 for converting coordinate position of the object is provided in a main storage unit 602 of said stereoscopic imaging system 501.

### BACKGROUND OF THE INVENTION

The present invention relates to a system for presenting a 3-dimensional image. In particular, the invention relates to a system for generating a stereoscopic image suitable for the reduction in the quantity of the hardware used and adequate for ensuring the proper perception of users by controlling the amount of parallax between pictures, which are presented to both eyes of a viewer.

Since many years, there have been strong demands on a stereoscopic display system. In recent years, with rapid progress and technical development to attain low cost production and high performance characteristics of digital image display system, stereoscopic display systems suitable for practical application have increasingly appeared in the market. Among traditional types of stereoscopic display systems, there are the systems based on anagram system using glasses with two different colors or based on polarizing glass.

Also, the systems for providing stereoscopic vision for naked eyes and stereoscopic vision from multiple visual points have been increasingly designed and produced in recent years. As such examples, the system using barrier system or the system using renticular lens, a system using lens array, etc. can be given.

In the cases of any of these types of display systems, images of the same object are obtained through observation from two or more visual points for the picture to be displayed. FIG. 23 is a drawing to show a situation where a stereoscopic display for naked eyes is applied.

As shown in FIG. 23, when a display device (stereoscopic image output unit) 100 of a stereoscopic image display system is seen from different visual points at visual point positions of 104, 105 and 106, images slightly different from each other as shown in images 101, 102 and 103 are given for each case. Due to parallax between these images, it looks as if objects may be stereoscopically present in the space in front of or behind the display device (stereoscopic image output unit) 100.

Depending on the visual point positions 104, 105 and 106, concrete schemes to show different pictures differ according to stereoscopic display method adopted by the display device (stereoscopic image output unit) 100. In this case, the problem commonly found for almost all types of stereoscopic image display systems is that an effective image should be prepared as seen from a plurality of visual points such as images 101, 102 and 103 for an object.

To prepare the original image, there are various methods: a method to actually take images by using a plurality of cameras, a method for manually drawing different pictures to reproduce stereoscopic image, and a method to prepare a plurality of images from a model with 3D information by means of calculation processing.

FIG. 24 is an imaginary drawing to show a method using 3D model. An object is retained as a 3-dimensional model 200, and pictures as seen from visual point positions 201-203 in a certain virtual space are prepared by calculation processing.

For arranging the visual point positions 201-203 in the virtual space, it is necessary to make arrangement to match the visual point positions 104-106 in FIG. 23 so that the stereoscopic image display system can be actually provided.

This method for preparing stereoscopic image by using a 3-dimensional CG model is now widely used because of the technical improvement in calculating ability of computers. This is now applied for preparing the animation images or for displaying the image with interactive performance characteristics at real time.

In many cases of the display of 3-dimensional CG model, surface portions are regarded as assembly of polygons (polygon meshes), and shape, color and reflection parameters are described and retained as 3-dimensional information of a 3-dimensional CG model 200. Based on the surface information, an image of the 3-dimensional CG model 200 can be calculated by simulation calculation.

To this 3-dimensonal CG model 200, positions and field angles of cameras 201-203 are set up virtually at visual point positions. The conditions of the rays entering the cameras 201-203 are simulated, and image information is prepared. This process to construct 2-dimensional image by lighting simulation is also used for the preparation of the types of CG images other than stereoscopic image, and it is generally called “rendering processing”.

Regarding the rendering operation of stereoscopic image as described above, JP-A-10-74269 (hereinafter referred as “Patented Reference 1”) discloses a method to automatically or manually correct parameters of camera so that movement on the screen can be property perceived without incongruity and in a manner suitable for human visual perception.

Also, JP-A-11-355808 (hereinafter referred as “Patented Reference 2”) describes an imaging system, in which stereoscopic property of a stereoscopic image can be adequately controlled. According to this reference, a stereoscopic image is prepared by synthesizing two types of 2-dimensional images. There is provided control means for preparing an image to alleviate the burden of the viewer from fatigue by controlling the amount of parallax in the synthesizing process.

Further, according to JP-A-2003-348622 (hereinafter referred as “Patented Reference 3”), the amount of parallax is gradually changed as time elapses from a preset initial value to the final value in order to reduce the burden of fatigue on the user side.

Also, JP-A-9-74573 (hereinafter referred as “Patented Reference 4”) proposes means for calculating the conditions of camera parameters so that total image of the object can be placed within a combination range of both eyes of a viewer.

### SUMMARY OF THE INVENTION

FIG. 25 is a drawing to show problems in a stereoscopic image display system as widely known at present. As already described in “Background of the Invention”, it is the characteristic feature of the stereoscopic image display system that stereoscopic effect can be provided because pictures different according to the visual points are introduced to the system. When it is attempted to display an object at a position considerably separated in distance from depth of screen surface, it is known that the fatigue of a viewer increases.

In FIG. 25, reference numeral 301 represents a range, within which stereoscopic vision can be maintained in front of and behind an actual display device (stereoscopic image output unit) 100. When it is tried to stereoscopically represent the object beyond this range as shown by stereoscopic images 302 and 303, the viewer cannot see it as a single object by stereo-matching or the viewer may feel excessive fatigue.

Also, when using a stereoscopic display for naked eyes, there is a case where images 101-103 to be sent to visual point positions 104-106 in FIG. 23 cannot be completely separated from each other because of the problem in performance characteristics. In such case, the images 101-103 seen at different visual point positions 104-106 may appear as different images in incomplete form. When deviation of images is increased in stereoscopic vision, such elements often inhibit natural way of viewing.

Therefore, a distance of depth, at which a stereoscopic image can be viewed in natural manner, depends on personal characteristics of the viewer and also on the ability of the stereoscopic image display system.

For this reason, in many cases at present, specialists in charge of preparing the image are experiencing trial and error and are trying to produce such stereoscopic contents that discomfort may not be given to the viewer. Compared with an ordinary image, it is necessary to shorten the time of viewing or to give special care on the reduction of the depth of the picture or the amount of motion.

In particular, as shown in FIG. 26, when it is tried to stereoscopically depict a 3D model in wide range, it is necessary to prevent excessive parallax between a background model 401 and a model 200 to be at the center of viewing or a foreground model 402 placed in foreground. For the preparation of the image, special care must be given according to experience and based on trial and error. Such trends become more conspicuous when a display image is prepared on the display for naked eyes, which has limitation in separation.

In the Patented References 1 and 4 as given above, description is given on a method, by which the viewer can adjust the stereoscopic image to a position easily observable by changing the camera parameters 3-dimensionally in virtual space.

However, with the changes of camera parameters, field angle of the picture or visual point position may vary. Even when the same object is observed, visual perception actually felt by the viewer might be different from the one initially intended by the designer and the producer of the system. Also, an image after the adjustment by the viewer may vary from the image, which the specialist in charge of preparation of contents has initially intended.

The Patented Reference 2 provides means for preparing an image without causing much burden on the viewer from fatigue by controlling only the amount of parallax under a certain rule. Further, the Patented Reference 3 describes that the amount of parallax is gradually changed as time elapses.

However, in case of the objects with striking difference in depth distance just as in the case of the background model 401 and the foreground model 402 shown in FIG. 26, parallax caused by the depth between these objects is extremely emphasized, and it is difficult to give proper consideration on stereoscopic property of the central model 200 itself.

As described above, when points where strict stereoscopic effect is needed and the points where excessive parallax occurs although stereoscopic effect is not essential are intermingled with each other within one screen, there are elements, which cannot be controlled or sufficient effect cannot be attained in the background art.

It is an object of the present invention to provide a system and a method, by which it is possible to perform processing on the component in depth direction as seen from specific visual point positions with respect to each visual point position coordinates in order to allow the restriction on hardware ability of a stereoscopic image display system and to be convenient for estimation of parallax amount allowable by a viewer when a scene constructed by a 3-dimensional model is prepared as an image.

By this processing, it is possible to prepare a stereoscopic image by excluding excessive parallax effect, and this is accomplished by designating, with respect to the inner part of a 3-dimensional scene, a region where stereoscopic effect is essential and a region where it is not.

The present invention comprises calculating means for producing a plurality of 2-dimensional images to be provided on a stereoscopic image display system by maintaining scenes constructed by structure information describing 3-dimensional configuration as information, means for maintaining an information of parallax amount allowable by a viewer, calculating means for processing the component in depth direction when each of vertex position coordinates are seen from a specific visual point position, numerical value calculating means to be used for the processing converting means for converting distance data such as a table with numerical values, and calculating means for reducing parallax amount between the images while maintaining the image as seen from a visual point, which serves as the center.

### BRIEF DESCRIPTION OF THE DRAWINGS

FIG. 1 is a drawing of a stereoscopic image display system according to Embodiment 1 of the present invention;

FIG. 2 is a block diagram of a stereoscopic imaging system 501 of Embodiment 1;

FIG. 3 is a flow chart of processing of Embodiment 1;

FIG. 4 is a flow chart of processing in Step 700 of FIG. 3;

FIG. 5 is a drawing to show data structure of a 3-dimensional CG model to be read in Step 801 of FIG. 4;

FIG. 6 shows data structure of vertex data in FIG. 5;

FIG. 7 shows data structure at a visual point position to be read in Step 802 of FIG. 4;

FIG. 8 is a flow chart of processing in Step 703 of FIG. 3;

FIG. 9 is a diagram to show meaning of each numerical value data used in Formula 1;

FIG. 10 is a diagram to represents contents of a function D(x) used in Formula 2;

FIG. 11 is a drawing to show modification of vertex data by Step 703 of FIG. 8;

FIG. 12 is a table to show data structure of image data stored in an image buffer 613;

FIG. 13 is a flow chart of processing in Step 704 of FIG. 3;

FIG. 14 is a drawing to show a stereoscopic image display system of Embodiment 2;

FIG. 15 is a flow chart of processing of Embodiment 2;

FIG. 16 is a drawing to show a stereoscopic image display system of Embodiment 3;

FIG. 17 is a flow chart of processing of Embodiment 3.

FIG. 18 is a drawing to show screens to confirm processing effects to be executed by Embodiment 3;

FIG. 19 is a drawing of a stereoscopic image display system of Embodiment 4;

FIG. 20 is a drawing to show a stereoscopic image display system of Embodiment 5;

FIG. 21 is a flow chart of processing of Embodiment 5;

FIG. 22 is a drawing to show a stereoscopic imaging system 2401 of Embodiment 5;

FIG. 23 is a drawing to show the relation between changes of visual point positions and display image in the stereoscopic image display;

FIG. 24 is a drawing to represent preparation of a stereoscopic image based on a 3-dimensional model and a plurality of visual point positions;

FIG. 25 is a drawing to show excessive depth and jumping-out of the image in the stereoscopic image display system; and

FIG. 26 is a drawing to show wide separation between a background image and a foreground image in a 3-dimensional model.

### DESCRIPTION OF THE PREFERRED EMBODIMENTS

Description will be given below on embodiments of the invention referring to the drawings.

### Embodiment 1

Here, description will be given on an embodiment of a stereoscopic image display system to show contents of stereoscopic image, in which stereoscopic characteristics of images due to parallax can be changed and adjusted depending on the distance of depth without changing the impression of the image to be seen at the position of the visual point position, which serves as the center of the view.

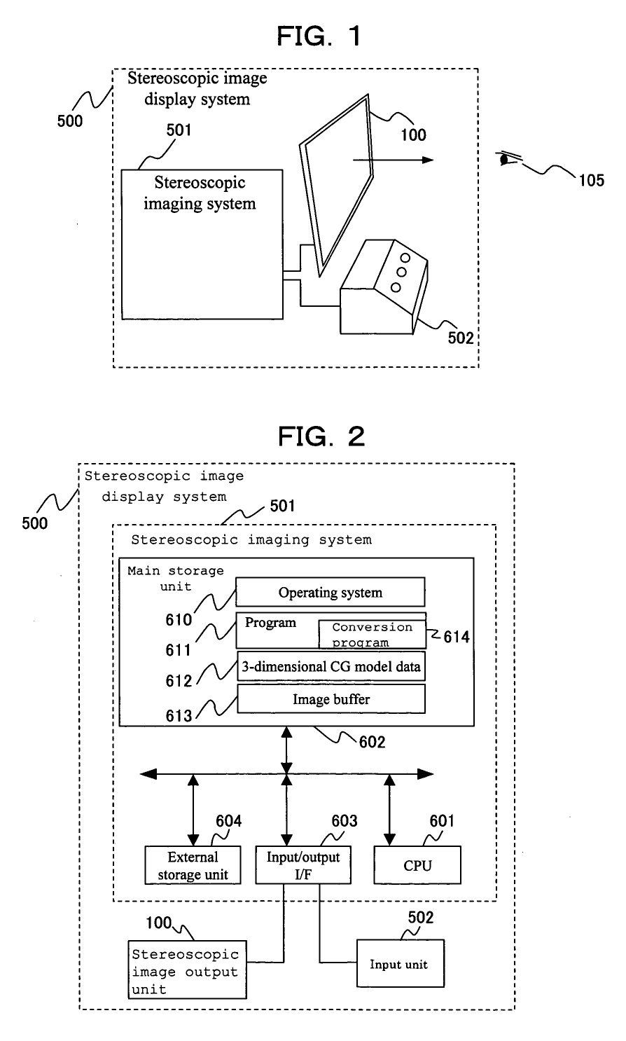

FIG. 1 shows an example of configuration of hardware devices in the present embodiment. Reference numeral 100 denotes a stereoscopic image output unit (display device). The arrangement and the details of this display device are similar to those of the existing type of display device. Reference numeral 105 denotes a visual point of a user, and reference numeral 500 represents a stereoscopic image display system, numeral 501 represents a stereoscopic imaging system to send image information to the stereoscopic image output unit 100, and numeral 502 represents an input unit to receive an instruction from the user.

FIG. 2 is a block diagram showing an example of the arrangement of the stereoscopic imaging system 501. A CPU (central processing unit) 601 carries out various types of processing according to programs stored in a main storage unit 602.

In the main storage unit 602 and an external storage unit 605, programs and data necessary for execution of control processing are stored. As the external storage unit 605, a hard disk drive or an existing type of large capacity media are used.

An input/output I/F 603 comprises means for transferring data necessary for giving and taking of input and output data between the stereoscopic image output unit 100 and the input unit for receiving the instruction from the user.

The instruction of the user is sent from the input unit 502. As the input unit 502, the existing types of input unit such as keyboard, mouse, touch panel, button, lever, etc. are used. The CPU 601 is provided with means for interrupt processing using timer, and it has a function to perform a series of operations preset for a certain period of time.

In the stereoscopic imaging system of the present embodiment, calculation processing is preformed according to an operating system 610 and a program 611 stored in the main storage unit 602. The 3-dimensional CG model data 612 stored in the main storage unit 602 and the image data in the image buffer 613 are updated, and the updated data are outputted to the stereoscopic image output unit 100.

Each portion of the program 611 is divided to partial operations called routines (steps). When these routines (steps) are called from the operating system 610 for performing basic control, the operation of the total system is carried out.

The arrangement of the operating system and the calling operation of the program are similar to those of the existing type of system, and detailed description is not given here. Now, description will be given on the operations specific to the present invention, which are carried out in the routines (steps).

In the present embodiment, the 3-dimensional CG model data 612 and input information from the user are received as input data. Processing to modify the input is carried out as appropriate. The image data prepared by this processing is stored in the image buffer 613, and the image data in the image buffer 613 is displayed on the stereoscopic image output unit 100.

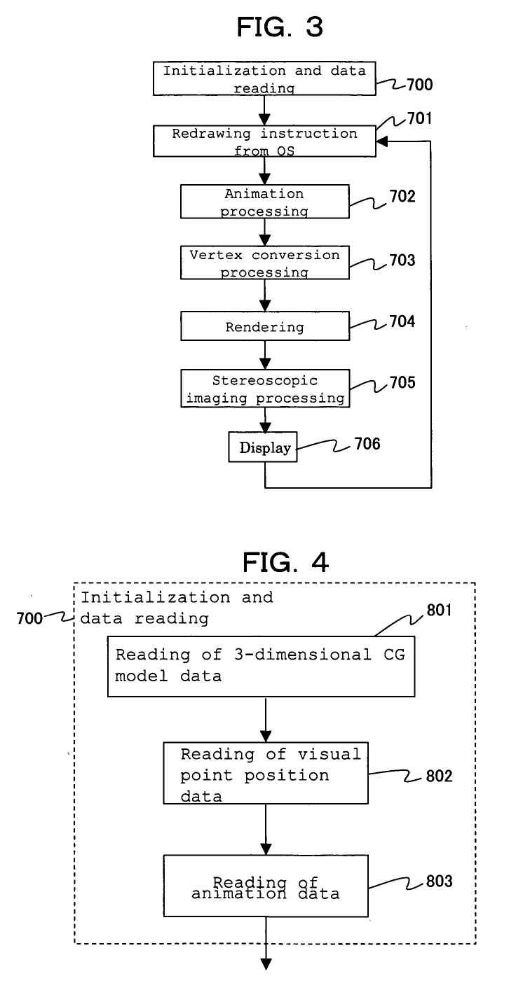

To carry out this operation, the procedures in Steps 700-706 of the routine processing flow as shown in FIG. 3 are stored as a part of the program 611.

Step 700 is a step for initialization and data reading including the input of the 3-dimensional CG model data 612. Step 701 is a step of redrawing the instruction from OS, which modifies the 3-dimensional CG model data 612 according to the input from the user. Step 703 is a step for animation processing.

Step 703 is a step for vertex conversion processing to change the position so that parallax amount between the images is reduced without changing the projecting position as observed from a visual point, serving as the center with respect to each of the vertexes, which constitute the 3-dimensional CG model data 612. Step 704 is a step for the rendering processing to prepare a 2-dimensional image from the 3-dimensional CG model data 612 and parameter of projection matrix. Step 705 is a step of processing to generate the stereoscopic image. Step 706 is a step to display a 2-dimensional image on a screen of the stereoscopic image output unit 100.

The processing in these Steps 700-706 is continuously performed in the order of the Steps shown in FIG. 3 for a certain preset time or each time as new input information is received from the user. As a result, the 3-dimensional model is displayed on the stereoscopic image output unit 100 as image information.

About the trigger to call the routine processing shown in FIG. 3, there are many existing method controlled by the operating system 610. Detailed description about this trigger timing should be selected from any of these known methods, and is not limited to one particular method here, because this selection depends on the implementation of operating system 610.

Detailed description will be given below on Step 700 for initialization and data reading and on Steps 702-705 for redrawing processing when Step 701 for redrawing instruction from OS is carried out, including concrete operation of each routine.

First, description will be given on Step 700 for initialization and data reading. In FIG. 4, the details of Step 700 for initialization and data reading are explained by using Step 801-803.

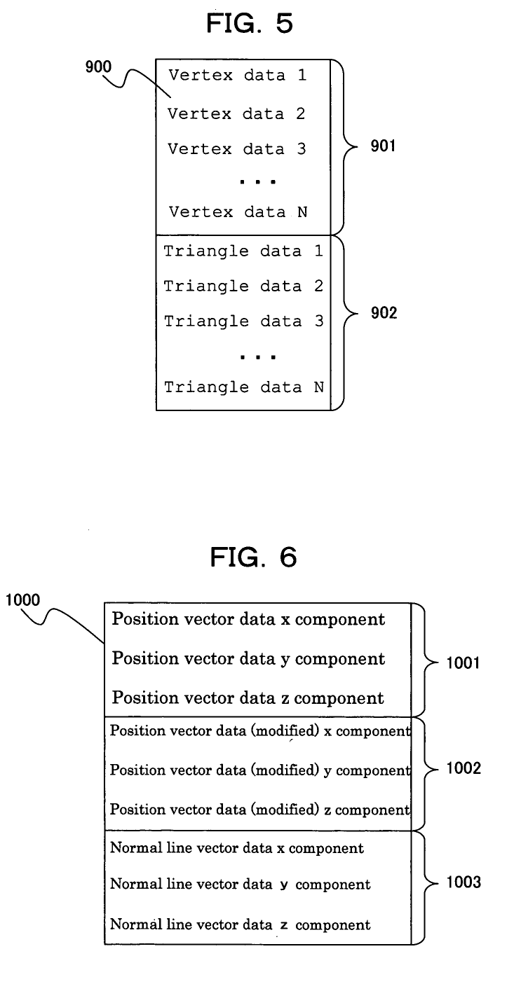

In Step 700 for initialization and data reading, the 3-dimensional CG model data 612 is read as shown in FIG. 4 (Step 801). The model data 612 is read from the external storage unit 604 and is written into the main storage unit 602. FIG. 5 shows an example of data structure of the model data 612.

The example shown in FIG. 5 is based on the data storage method of triangle mesh type, which is a representative existing technique to maintain a data structure 900 of the 3-dimensional CG model. According to this method, surfaces of an object are regarded as an assembly of triangles, and various types of position information on the vertexes of the triangles are retained as a structure body.

In the present embodiment, such manner of storage as given above to store the model information is adopted, while the present invention can also cope with the case where 3-dimensional information is retained by polygon data or voxel data or with the case where it is retained by piecewise function such as spline or Bezier surface.

Numeral 901 shown in FIG. 5 represents arrays to retain the data of vertexes. Each of the vertex data is as given in data structure 1000 shown in FIG. 6. Data structure 1001 is a position vector data, and it is given by a value to indicate 3-dimensional position in virtual space in orthogonal coordinate system (x,y,z).

The 3-dimensional position vector data 1001 are made up with a set of three floating points. Numeral 1002 represents a region where coordinate position is stored when the processing to change according to the present invention is applied. Detailed description will be given later on the contents to be stored in this region.

A data structure 1003 represents a normal line vector data (unit vector) with a length of 1 to indicate the direction of a normal line on the surface of the object with respect to the vertex position, and it is stored as the data to retain a set of three floating points. In addition, when the existing technique is applied such as color information, texture information, etc. for each vertex, these types of information can be added further to the structure body.

The data structure 902 shown in FIG. 5 contains triangular data 1 to N, and these are index values of vertexes, which are set up in one set of three. By following the vertexes in the order from 1 to N, a triangle is defined. The surface of the object is made up by an assembly of these triangles.

When the data shown in FIG. 5 and FIG. 6 are read on the main storage unit 602, the data necessary for the construction of the 3-dimensional CG model are prepared (Step 801 in FIG. 4).

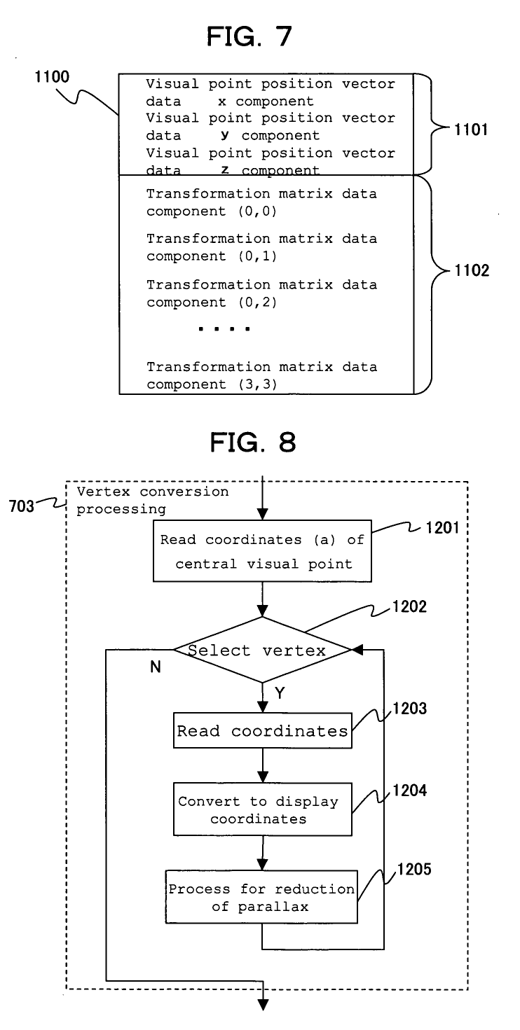

Next, as Step 802 shown in FIG. 4, data structure 1100 (FIG. 7) to express visual point positions of cameras 201 to 203 shown in FIG. 24 in virtual space is read as many as required (i.e. as many as the virtual visual point positions required by the stereoscopic output unit 100).

The data structure 1100 shown in FIG. 7 retains initial visual point position of the user. The data structure 1101 is a vector data of visual point vector data, which indicates gaze points (positions of cameras 101-203) in virtual space from a point corresponding to the center of the stereoscopic image output unit 100.

Also, data structure 1102 indicates initial value of matrix to convert the coordinate point in virtual space to orthogonal coordinate system aligned with the display space of the stereoscopic image output unit 100.

By applying this matrix to a certain coordinate value in the virtual space, it is converted to coordinate system with Z direction directed in the direction of normal line to the stereoscopic image output unit 100 by using the point projected on the stereoscopic image output unit 100 (where vergence of parallax is turned to 0) when the stereoscopic display is performed. The data structure 1101 indicates visual point vector data of a virtual visual point in this coordinate system.

In the stereoscopic image display system, information of the virtual visual point is present in a set of two or more types of information. The parameters such as number of information, visual point position, and field angle depend on the arrangement and the packaging procedure of the stereoscopic image output unit 100 as well as on the design when the stereoscopic image display system is operated.

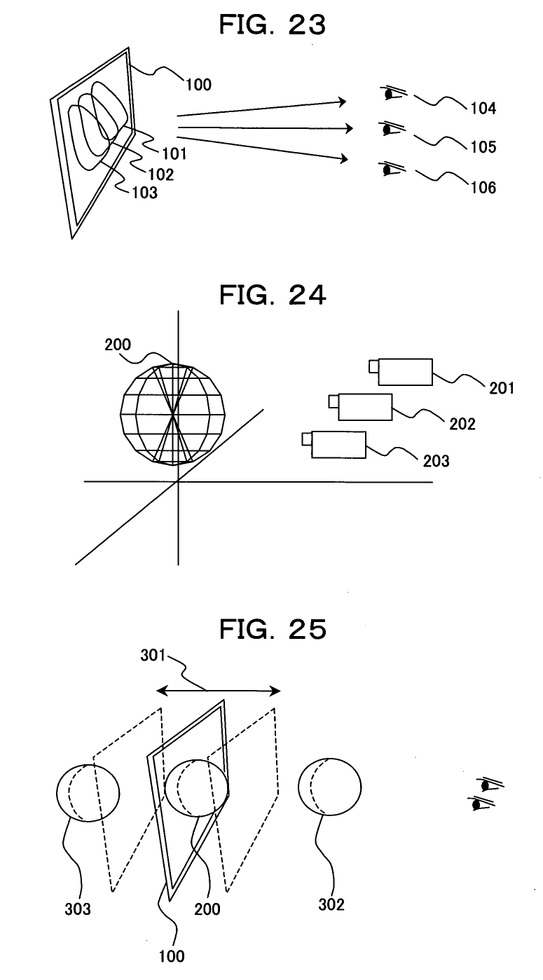

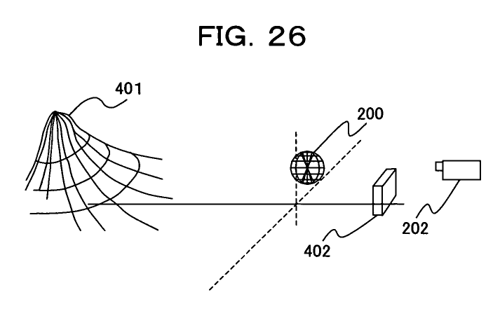

When the stereoscopic image display system is observed, a visual point position 105 (FIG. 23) serving as the center is set up, and a position of a camera 202 (FIG. 24) on virtual space to match the visual point position is designated. In particular, the information of this camera 202 is also designated in the step as explained later as the central visual point position.

In Step 802 shown in FIG. 4, a position data (3-dimensional vector) indicating the initial value of the position, which acts as the center of the stereoscopic image output unit 100 in virtual space, and the values to indicate the size of the stereoscopic image output unit 100 are read at the same time.

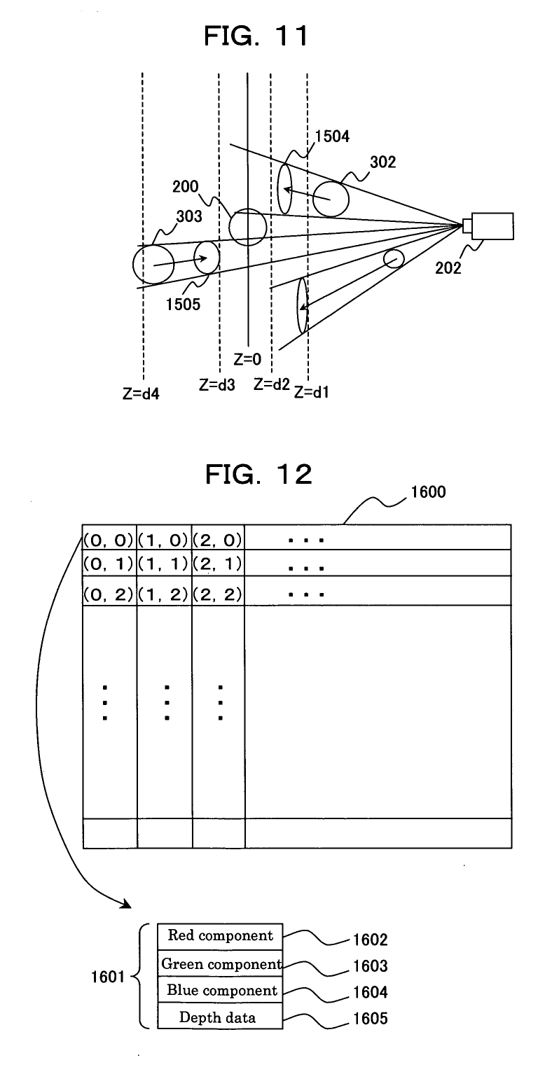

The values d1 to d4 of FIG. 11 as explained later are read, which expresses the range of application for standard depth of the stereoscopic image output unit 100. In the range from d1 to d4, the stereoscopic image output unit 11 is projected for a distance, which is preset so that it does not go beyond the critical point for the user. Hereinafter, this is referred as “allowable region”. The range from d2 to d3 is a range where the viewer near the stereoscopic image output unit 100 can easily see the stereoscopic object. This is referred as “recommended region”.

Finally, in Step 803 shown in FIG. 4, the data necessary for performing the animation processing with respect to the 3-dimensional CG model is read.

For the animation processing to be performed to the 3-dimensional CG model, the existing technique also used in non-stereoscopic rendering such as skin mesh processing can be directly used, and detailed description is not given here. When various data as described above have been read, Step 700 for initialization and data reading shown in FIG. 3 is completed.

Next, description will be given on a series of Steps 702-706 to be executed when a trigger for drawing is issued from OS (Step 701).

In Step 702 shown in FIG. 3, information necessary for changing the 3-dimensional CG model is inputted. Animation processing of 3-dimensional CG model or processing to change the visual point position are included in it. Specifically, by referring to time transition and input of the users, the processing to change the model such as animation processing is applied to the data structure of the 3-dimensional CG model, and the data structure 1001 is sequentially modified. On the animation processing or on the change of visual point position, detailed description is not given here because this belongs to the existing technique generally in practice as the procedure for application of the 3-dimensional model regardless of whether it is stereoscopic or non-stereoscopic.

Similarly, visual point position is changed according to the time transition and the input information from the user. When translational shifting of the visual point position is expressed by using matrix T and rotational shifting is expressed by using matrix R, a synthetic matrix TR for translational shifting and rotational shifting is prepared to each 3-dimensional vector to indicate position of the gaze point, position of each visual point, and orthogonal coordinate system, and a product (TRV_i) with matrix V_i (i.e. transformation matrix data 1102 in FIG. 7) to indicate position information of each visual point information can be calculated. For the processing to change the visual point position and the input unit, the procedures in the existing technique are available.

Using the 3-dimensional CG model prepared in Step 702 of FIG. 3 and the information of visual point position, routine processing to change the position is carried out so that the amount of parallax between visual points is reduced without changing the projecting position when seen from the visual point, serving as the center with respect to each of the vertexes, which constitute the 3-dimensinal CG model.

This routine processing is the processing specific to the present invention. The routine processing is executed by using a transformation program 614 of the coordinate position prepared on the storage unit 600. Description will be given below on the details of the routine processing referring to the flow chart shown in FIG. 8.

In Step 1201 of FIG. 8, position information of the central visual point is read. This information is indicated in Step 701 of FIG. 3, and it is a value of 3-dimensional vector as defined in display coordinates. Hereinafter, the value of this vector data is referred as In Step 1202, the data of a vertex not yet selected is selected from the data structure 900. In the next Step 1203, position vector data of the vertex data is read from the data structure 1000. Hereinafter, this vector value is referred as “p_i”.

In Step 1204, position vector data 1001 (p_i) of each vertex is converted to 3-dimensional vector “p” in the display coordinates. The symbol “p” represents a coordinate value of display coordinate system, which is obtained by applying TRV_i to the position vector data p_i of vertex position.

In Step 1205, a position vector data 1002 (q) for drawing is calculated from the position vector data p_i. This conversion processing is carried out by using the values of the following Formula 1:

$$q = \vec{a} + ( \frac{D ( {a}_{z} + \vert \vec{p} - \vec{a} \vert {d}_{z} )}{{d}_{z}} + s ) \cdot \vec{d} \\ s = {a}_{z} / {d}_{z} \qquad [ Formula 1 ]$$

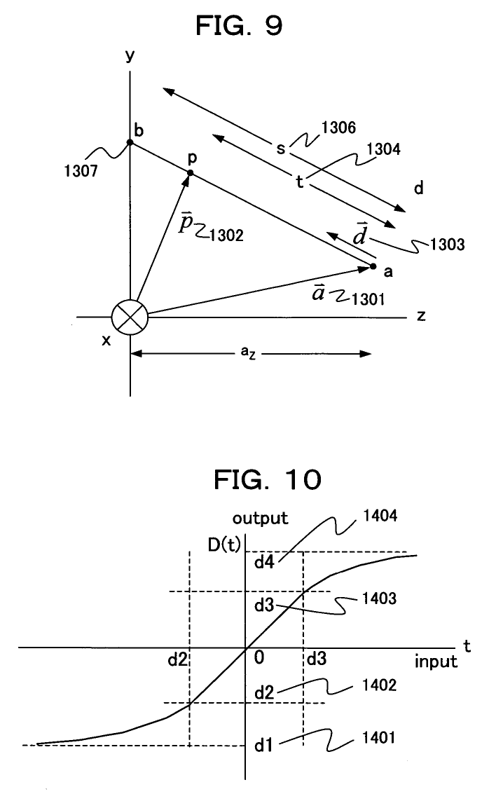

The symbols given in Formula 1 are defined as shown in FIG. 9. FIG. 9 is a diagram in the display coordinate system. It is supposed that abscissa in the diagram indicates Z direction, the vertical direction represents Y direction, and a direction toward the depth of paper surface is X direction.

Within this coordinate system, vector “a” is a position vector 1301 at a visual point position “a” of the camera 202 (FIG. 24), which serves as the center. Vector “p” is a position vector 1302 of a vertex p, which is an object to be converted. Vector “d” is a unit vector 1303 with a length of 1 and is directed toward the vector “p” from the vector “a”. The symbol d_{z} stands for z component of the vector “d”, and the symbol a_{z} represents z component of the vector “a”.

The symbol “t” represents a distance 1304 between the vector “p” and the vector “a”. The symbol represents an intersection 1307 between a straight line extended from the visual point position “a” toward the unit vector “d” and a plane where Z=0. The symbol “s” represents a distance 1306 from “b” to “a”.

Here, D(x) in Formula 1 is a function of one variable shown in FIG. 10. This function is controlled by four values of d1-d4 (1401-1404). The following three conditions are required so that this function provides the effects of the present invention.

1: A function with monotonous increase. That is, in case there are two numerical values given as “t” (where t1>t2), the condition of (D (t1)≧D (t2) is satisfied.

2: There are upper limit and lower limit. In case “t” advances in negative direction (a direction toward visual point position “a”), i.e. when a distance between the visual point position “a” and the vertex position “p” is turned closer to 0, the value D(t) after conversion is never turned to a value, which is equal to or lower than the fixed value d1. As a result, parallax over the fixed value does not occur on the screen.

When the value “t” is increased in positive direction (i.e. in a direction where the vertex position “p” is separated away from the visual point position “a”), there are the following two cases:

(1) The first is a case where the amount of parallax is at a distance of infinity, and it is turned to a value equal to or more than the allowable limit of parallax. In this case, a function, which is not turned to d4 or more when t=∞, is defined as D(t).

(2) The second case is a case where the amount of parallax at the distance of infinity can be suppressed to the allowable limit of the parallax. In this case, it is not necessarily required to set the upper limit d4.

3: There is linearity near the gaze point. Specifically, in the range up to the vicinity of t=0 (t=d2 to d3), linear or almost linear conversion is carried out. In so doing, within this range, a stereoscopic shape given by the use of the coordinate “q” represents a shape approximately similar to stereoscopic configuration given by the coordinate “p”.

For the packaging of the conversion program 614 to satisfy these three conditions, there are various methods, i.e. to convert by using a reference table or to use piecewise polynomial function such as spline function, or to use mathematical function. One example of the mathematical function to satisfy the above conditions is given in Formula 2:
y=(d₄−d₃)·2/π·tan⁻¹((x−d₃)·π/2)+d₃(d₃<x)
y=x(d₂<x<d₃)
y=(d₂−d₁)·2/π·tan⁻¹((x−d₂)·π/2)+d₂(d₂>x) [Formula 2]

In the present embodiment, this function is defined as D(x) (this function is executed by the conversion program 614 at the coordinate position), while the present invention can also be attained by the use of any other method, which satisfies the above conditions. By carrying out the processing as give above, the data 1002 of the vertex “q” with respect to the data 1001 of each vertex “p” can be obtained.

FIG. 11 shows a relation between the 3-dimensional model by the vertex group “p” and the 3-dimensional model by “q”. The two models 200 are concurrent with each other in the vicinity of a plane Z=0. In case the 3-dimensional model by “p” (302, 303) is separated from the plane Z=0, the 3-dimensional model by “q” is shifted to a position (1504, 1505) near the plane Z=0.

However, in case of the model 200, which is prepared by mapping on the plane Z=0 by projection matrix as seen from the central visual point position, the 3-dimensional model by “p” and the 3-dimensional model by “q” have the same configuration on a 2-dimensional plane.

Next, in Step 704 of FIG. 3, the rendering processing is carried out by using the vertex data “q” and the vertex data “p” as converted in the above Step. There are many existing techniques for such rendering processing. As a representative technique, scan line technique is used in the present embodiment.

However, vertex conversion has been performed in the preceding step, and it is different from ordinary rendering method in that the data “p” to be read from initial data and the data to be read from the data “q” after conversion should be used separately depending on each case.

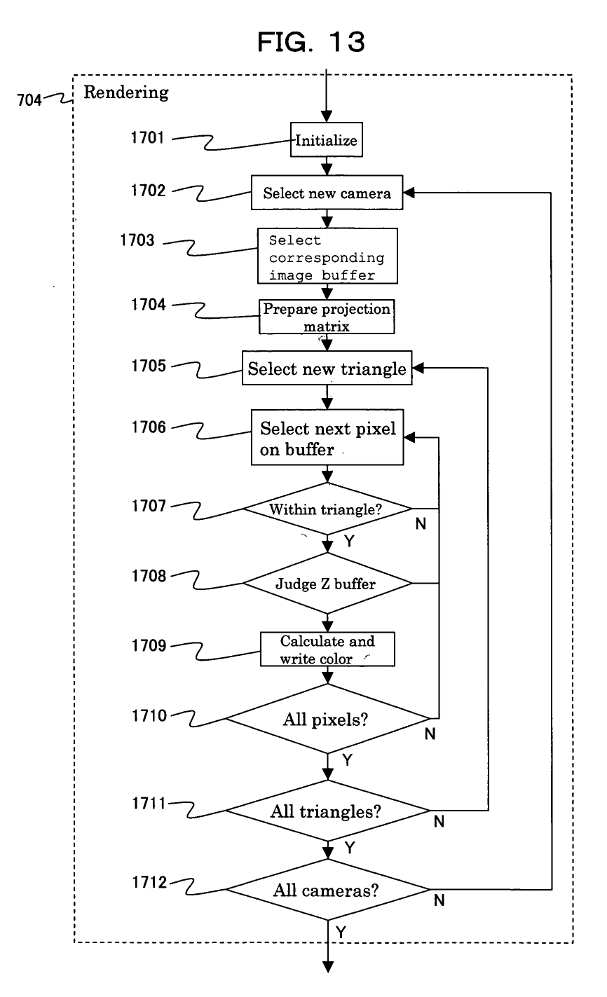

This processing is shown in the data structure of FIG. 12 and the flow chart of FIG. 13. Reference numeral 1600 in FIG. 12 represents 2-dimensional array of w X h (width X height). This corresponds to an image data with w pixels (in width) and h pixels (in height).

In Step 704 of the rendering processing, as many image data as the number of cameras used are constructed. As each element of the array, data structure 1601 is stored. This data structure 1601 comprises a red component 1602, a blue component 1603, and a green component 1604 stored as numeral data of 0 to 1. Also, a depth data 1605 is stored as numerical data of the floating point for depth information.

This data structure 1601 can be called by using the position on 2-dimensional array data structure 1600 (integral coordinate values in longitudinal and lateral directions). This data structure 1601 is referred as “pixel” hereinafter.

In Step 1701 shown in FIG. 13, initialization processing is performed for each pixel. In this initialization processing, “0” is written to the red component 1602, the blue component 1603, and the green component 1604 of the structure of pixel respectively. Also, “0” is written to the depth data 1605.

In the next Step 1702, a data structure 1100 (FIG. 7) at a certain camera position is selected. Also, a region of the corresponding image buffer is selected fro a region 613 (FIG. 2) of the main storage unit (Step 1703). In Step 1704, projection transformation matrix is prepared according to the information of this camera position.

For each of the triangles expressed by the data structure 900 (FIG. 5), the following processing is performed: First, a triangle not yet selected is selected (Step 1705). A pixel of the data structure 1600 in the image buffer is selected (Step 1706).

When the 3-dimensional position vector “q” (1002 in FIG. 6) retained by the vertex data of the triangle is multiplied by the above projection transformation, the corresponding three points are obtained on 2-dimensional image. Then, it is judged whether the selected pixel is surrounded by the triangle, which connects these 3 points (Step 1707).

If it is surrounded, advance to Step 1708. If not surrounded, go back to Step 1706, and a new pixel is selected.

For the pixel thus selected, the order of before-and-after is judged on the triangle already drawn and on the new triangle. This method is a modification of the existing technique called “Z buffer method” modified for the present invention. In case a triangle already drawn on screen is closer to this side from the depth of a triangle to be drawn (referring to a depth data 1605), go back to Step 1706 without drawing. Then, select a new pixel and repeat the judgment procedure (Step 1708).

A reciprocal number of a distance (between 3-dimensional position on a surface of a triangle reflected on the pixel newly drawn and 3-dimensional position of the camera) is written to the variable of depth information of pixel structure.

However, in the judging procedure based on this Z buffer method, vertex data of the coordinate “p”, and not the coordinate “q”, is used. Also, the depth data based on the coordinate “p” is written in the depth data 1605 as Z buffer region.

Next, in Step 1709, color information is written in the region as appropriate by calculating color of the surface from light source position, visual point position, direction of normal line, and color information. As the method to determine color information on the surface used, the existing method should be applied.

In the present invention, however, the value of 1003 shown in FIG. 6 is used as normal line vector to be used for calculation of the color information so that no influence of the procedure in Step 703 of FIG. 3 is exerted on color calculation.

When processing has been completed for all pixels, select a new triangle and repeat the procedure (Step 1710).

By repeating this procedure for all of the triangles (Step 1711), the image is completed. When the image has been completed, an image is prepared on new visual point position (Step 1712). When the image has been completed for all of the visual point positions, the procedure of Step 704 in FIG. 3 is terminated.

In Step 705 shown in FIG. 3, a stereoscopic image is displayed by using picture of each camera obtained in Step 704. As the procedure to prepare the final display image of the stereoscopic image from the picture of each camera, the same procedure as the procedure practiced in the existing technique is used depending on the type of the stereoscopic image output unit 100. For instance, according to anagram method, a new image is prepared by synthesizing color information of each pixel from every two initial images. According to renticular method, pixels are rearranged in a fixed order from the initial image for each plurality of numbers, and a new image is prepared.

In the present invention, the display method is not limited by the existing method for the stereoscopic image output unit 100. Because this Step 705 depends on internal structure of the display method of the stereoscopic image output unit 100, no further description is given on Step 705 in the present specification.

In Step 706, an image is displayed on the stereoscopic image output unit 100. Because the existing technique is used for the display step, no detailed description will be given in the present specification.

Through a series of flows as described above, a stereoscopic image is transferred to the stereoscopic image output unit 100. By repeating the procedure as described above, the continuously changing stereoscopic image can be displayed in continuous manner.

### Embodiment 2

Embodiment 2 relates to an arrangement where the amount of parallax is interactively controlled according to input information of the user.

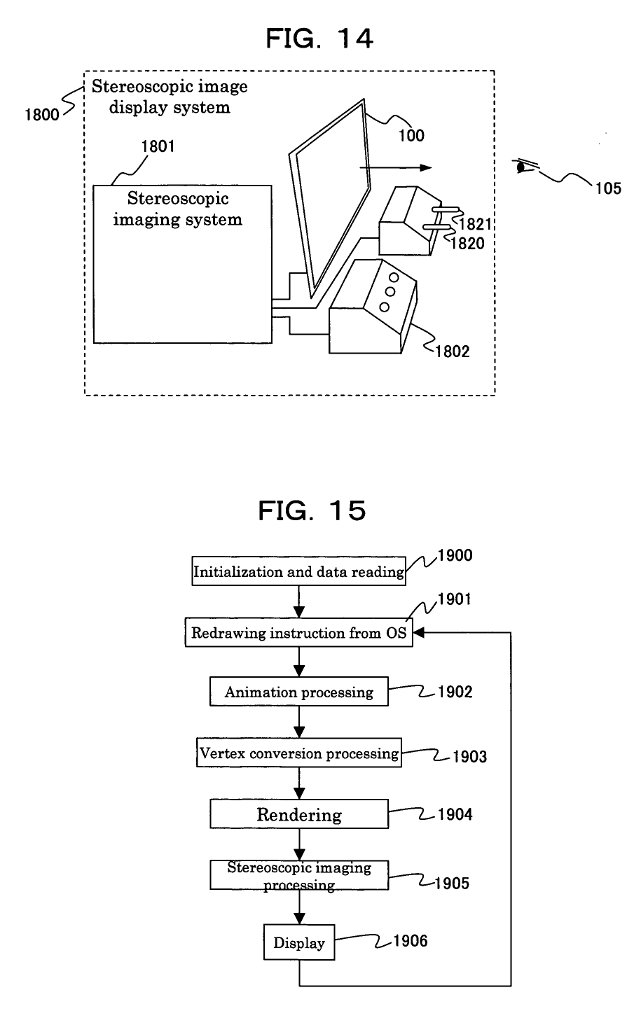

FIG. 14 shows hardware configuration of the present embodiment. A stereoscopic image display system 1800, a stereoscopic imaging system 1801 and an input unit 1802 correspond to 500, 501 and 502 of Embodiment 1 respectively. Compared with Embodiment 1, a lever 1820 and a lever 1821 are added.

A viewer at a central visual point 105 can operate the levers 1820 and 1821 while viewing the stereoscopic image output unit 100. In this case, the values set up by the lever can be read sequentially as decimal values from 0 to 1.

The flow of processing in the present embodiment is shown in FIG. 15. The procedures in Steps 1900-1902 and 1904-1906 of the processing flow are the same as the procedures in Steps 700-702 and 704-706 of Embodiment 1 respectively.

The difference from Embodiment 1 is that the value of the lever 1820 and the value of the lever 1821 are read in Step 1903. In Step 1903, the procedure similar to that of Step 703 is carried out. When the vertex coordinate “q” in Step 1204 is calculated in Step 703, a product of a value read from the lever 1802 with the initial value is used as the value d2 of the display recommended distance and the value d3 of the display recommended distance.

As the value d1 of the display allowable distance and the value d4 of the display allowable distance, a product of the value read from the lever 1821 with the initial value is used. By substituting these values, calculation is performed in the same manner as in Step 703 of Embodiment 1.

By changing the input information from this lever, the viewer can control the width of the effective region and the recommended region and can specify stereoscopic effect of the image to any value as desired.

### Embodiment 3

Embodiment 3 relates to an arrangement where the present invention is applied for the preparation of a stereoscopic image. FIG. 16 shows hardware configuration of this embodiment. The operations of the lever 2020 and the lever 2021 are the same as in Embodiment 2.

In the present embodiment, a monitor 2022 of another screen is provided. By sending an image signal from the stereoscopic imaging system 2001 to this monitor 2022, a non-stereoscopic image can be displayed.

Also, a switch 2023 is provided. By this switch 2023, integral value can be read and visual point position data to be used in the rendering processing can be set up by number. The setting information of this switch 2023 can be read from the stereoscopic imaging system 2002. Further, a switch 2024 is provided, and two values of On/Off can be set. The setting information of this switch 2024 can also be read from the stereoscopic imaging system 2001.

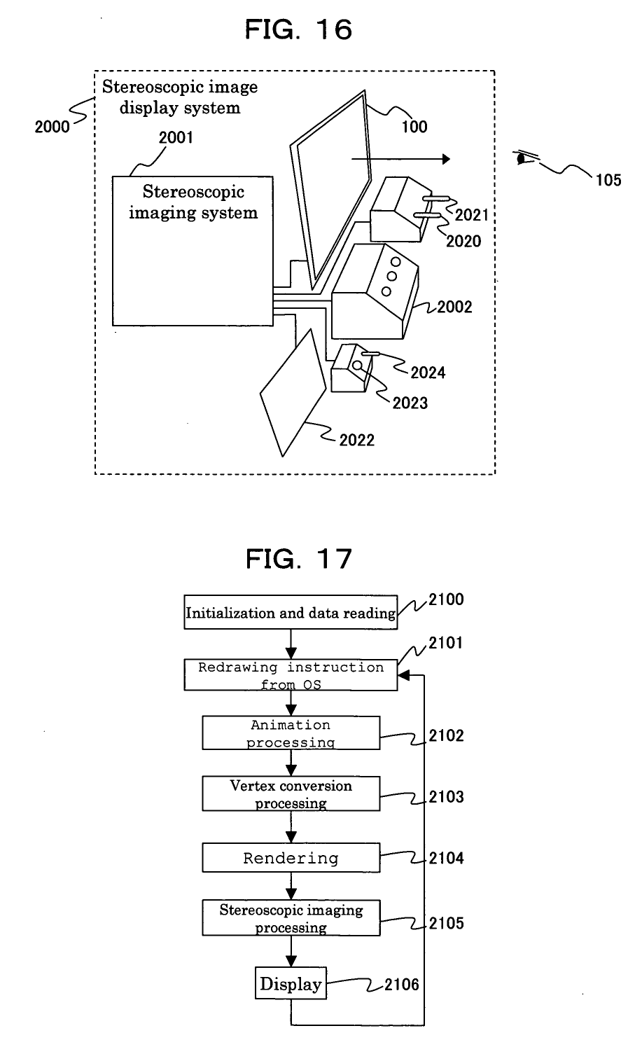

The flow of processing in this embodiment is shown in FIG. 17. The procedures in Steps 2100-2106 in the flow of processing are approximately the same as those of Steps 1900-1906 in Embodiment 2.

In the present embodiment, however, camera information to be read in Step 2100 contains one or more types of camera information different from camera information needed by stereoscopic image output unit 100 for giving a stereoscopic image.

In Step 2102, this camera information can receive information of the user independently from other camera information and can change parameters such as position, angle, etc.

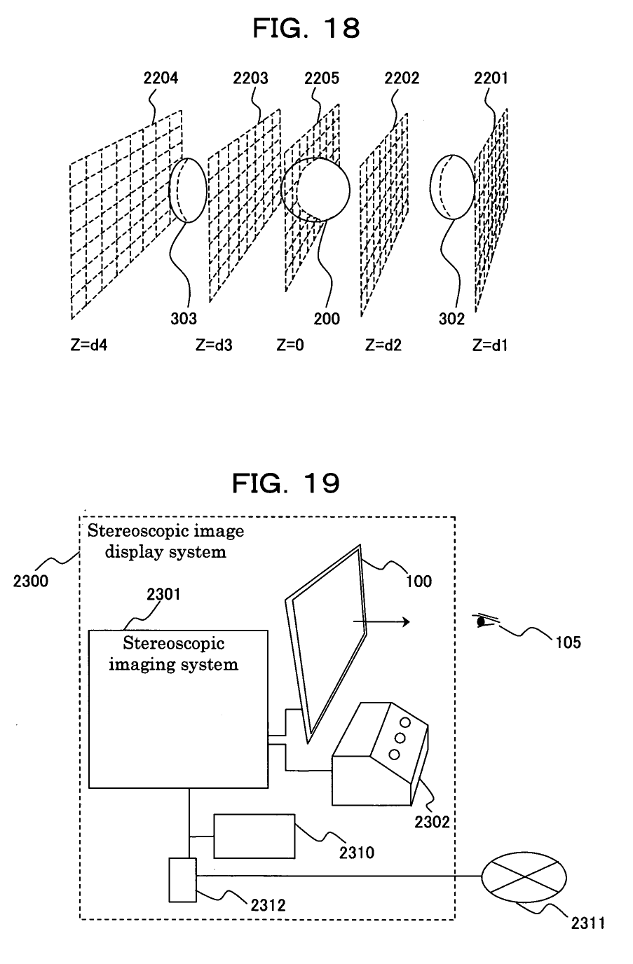

When the rendering processing in Step 2104 is performed, different types of icon information (2201-2204) to indicate the values d1, d2, d3 and d4 respectively are given by rendering as semi-transparent planes shown in FIG. 18 to the image obtained by this camera information.

These planes are the planes to have Z=d1, Z=d2, Z=d3 and Z=d4 in the display coordinates. By drawing lattice pattern for reference with respect to these planes, the planes can be made observable. Also, the position corresponding to the frame of the stereoscopic image is drawn in planar shape of Z=0. A reference lattice pattern 2205 as a semi-transparent frame is displayed, and the rendering processing is preformed.

In Step 2106, the stereoscopic imaging system 2001 sends an image of camera number designated by the switch 2023 to the monitor 2022. The viewer determines adequate values for d1, d2, d3 and d4 while viewing the monitor 2022.

Further, in case the switch 2024 is turned on when the procedure in Step 2100 is carried out, the same image information as the information outputted to the stereoscopic image output unit 100 is also sent to the external storage unit and is stored. After the completion of the storage processing, the information stored in the external storage unit is sent to the stereoscopic image output unit 100, and the same scene can be reproduced on the monitor 2022.

### Embodiment 4

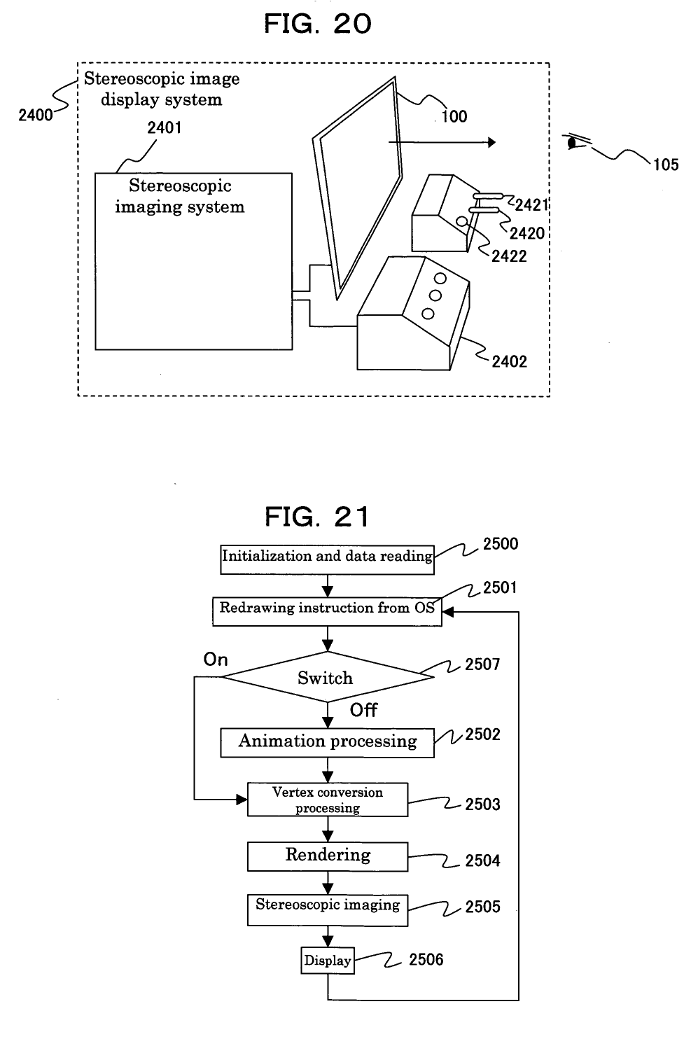

Embodiment 4 relates to an arrangement where the present invention is applied as a viewer of 3-dimensional model. As the technical arrangement where a 3-dimensional model prepared by the user is interactively viewed, the existing technique such as VRML (virtual reality modeling language) is known. FIG. 19 shows hardware configuration of the embodiment.

The difference from Embodiment 1 is that there are provided a reading device 2310 for external media and a connection device 2312 with an external network 2311.

For the packaging of the device 2310, the existing types of media such as floppy disk, CD-ROM drive, DVD-ROM drive, etc. can be used. For the packaging of the device 2312, the existing type of TCP/IP connection device can be used.

The user transfers the information of the 3-dimensional model prepared outside and can use this 3-dimensional model as a substitute for the 3-dimensional CG model 612 in Embodiment 1. The subsequent procedure is similar to that of Embodiment 1.

### Embodiment 5

Embodiment 5 relates to an arrangement where the present invention is applied for interactive 3-dimensional application. There are various types of this application including the application for amusement purpose.

FIG. 20 shows hardware configuration of this embodiment. A stereoscopic image display system 2400, a stereoscopic imaging system 2401, an input unit 2402, a lever 2420 and a lever 2421 correspond respectively to 1800, 1801, 1802, 1820 and 1821 in Embodiment 2. Compared with Embodiment 2, a switch 2422 is additionally provided.

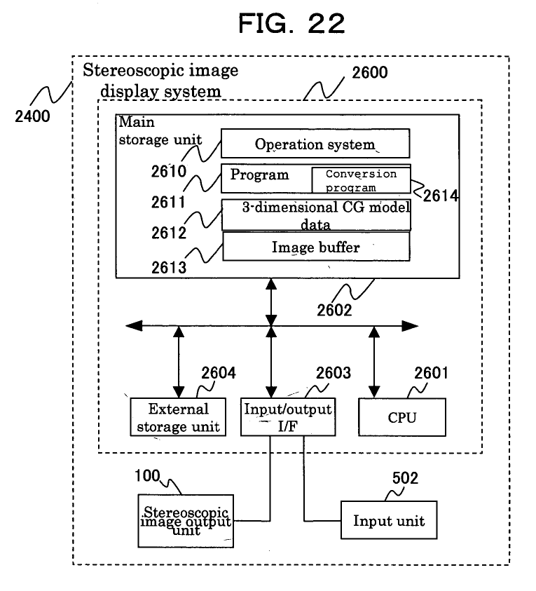

In the processing flow shown in FIG. 21, the procedures in Steps 2500-2506 are similar to those in Steps 1900-1906 of Embodiment 2. FIG. 22 shows the arrangement of the stereoscopic imaging system 2401 in the stereoscopic image display system 2400 in FIG. 20. The procedures in Steps 2601-2604 and 2610-2614 are similar to those in 601-604 and 610-614 in Embodiment 1.

However, in the program 2611 stored in the main storage unit 2602, a program is included, which reproduces and makes branch decision for the order displayed and the procedure of operation of 3-dimensional model in the reproduction of animation according to a preset scenario and the input information of the user. The existing technique is applied to interactive application to be reproduced according to this procedure.

A switch 2422 is an input device to stop the operation of Step 2502. The stereoscopic imaging system 2401 reads the on/off conditions of this switch in Step 2507. When this switch 2422 is turned on, the control of the situation at real time is skipped, while display operation of the stereoscopic image in Steps 2503-2506 are continued.

Therefore, under the condition where this switch 2422 is turned on, only the input operations of the lever 2420 and the lever 2421 are accepted. By utilizing this function, the user can adjust proper viewing condition of the stereoscopic image independently from real time processing of Step 2502 or from the execution of the scenario.

According to the present invention, it is possible to provide a stereoscopic image comfortably and without giving fatigue to the viewer and without changing the arrangement of the image as seen from visual point position serving as the center in such manner as to be suitable for the properties of the stereoscopic image and for the operating conditions of the stereoscopic image display system.

What is claimed is:

1. A stereoscopic imaging system for generating a stereoscopic image based on parallax effect, comprising means for preparing a stereoscopic image from a 3-dimensional model, and means for processing the stereoscopic image thus prepared to exclude excessive parallax effect while properly maintaining stereoscopic property of a particular 3-dimensional display region.

2. A method for generating a stereoscopic image based on parallax effect, said method comprising the steps of preparing the stereoscopic image from a 3-dimensional model, and of processing the stereoscopic image thus prepared in order to exclude excessive parallax effect while properly maintaining stereoscopic property of a particular 3-dimensional display region.

3. A stereoscopic imaging system according to claim 1, wherein there is provided means for designating an allowable region to exclude excessive parallax effect.

4. A stereoscopic imaging system according to claim 1, wherein there is provided means for designating a recommended region where stereoscopic property is properly maintained.

5. A stereoscopic imaging system for generating a stereoscopic image based on parallax effect, comprising means for preparing the stereoscopic image from a plurality of 2-dimensional images, and means for processing the stereoscopic image thus prepared in order to exclude excessive parallax effect while properly maintaining stereoscopic property of a recommended region.

6. A stereoscopic image display system, comprising a stereoscopic image output unit for displaying a stereoscopic image based on parallax effect and a stereoscopic imaging system for generating a stereoscopic image, wherein said stereoscopic imaging system comprises means for preparing the stereoscopic image from a 3-dimensional model and means for processing the stereoscopic image thus prepared in order to exclude excessive parallax effect while properly maintaining stereoscopic property of a recommended region.

7. A stereoscopic image display system, comprising a stereoscopic image output unit for displaying a stereoscopic image based on parallax effect and a stereoscopic imaging system for generating a stereoscopic image, wherein said stereoscopic imaging system comprises means for preparing a stereoscopic image from a plurality of 2-dimensional images and means for processing the stereoscopic image thus prepared in order to exclude excessive parallax effect while properly maintaining stereoscopic property of a recommended region.

8. A conversion program for generating a stereoscopic image based on parallax effect, said program comprising the steps of preparing the stereoscopic image from a 3-dimensional model and of processing the stereoscopic image thus prepared in order to exclude excessive parallax effect while properly maintaining stereoscopic property of a recommended region.

9. A conversion program for generating a stereoscopic image based on parallax effect, said program comprising the steps of preparing the stereoscopic image from a plurality of 2-dimensional images, and of processing the stereoscopic image thus prepared in order to exclude excessive parallax effect while properly maintaining stereoscopic property of a recommended region.

10. A conversion program used in a stereoscopic image display system, comprising a stereoscopic image output unit for displaying a stereoscopic image based on parallax effect and a stereoscopic imaging system for generating a stereoscopic image, wherein said program comprising the steps of preparing a stereoscopic image from a 3-dimensional model being provided on said stereoscopic imaging system, and of processing the stereoscopic image thus prepared in order to exclude excessive parallax effect while properly maintaining stereoscopic property of a recommended region.
